(19) United States
(12) Patent Application Publication
(10) Pub. No.: US 2007/0052349 A1
(43) Pub. Date: Mar. 8, 2007

(54) Electroluminescent device

(75) Inventors: Andrea Giraldo, Eindhoven (NL); Herbert Lifka, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/556,614

(22) PCT Filed: May 12, 2004
(86) PCT No.: PCT/IB04/50666

§ 371 Date: Nov. 15, 2005

(30) Foreign Application Priority Data
May 19, 2003 (EP) 03101410.3

(51) Int. Cl. H01J 1/62

(52) U.S. Cl. 313/506; 313/509; 313/498

(57) ABSTRACT

An electroluminescent device (1) comprising a lower electrode layer (10), and an upper electrode layer (2), which are both connectable to a driving circuit (3) and electrically accessible from below, is disclosed. One or more functional layers (5) are disposed between the electrode layers (2, 10) to form an electroluminescent area The device (1) comprises a relief pattern comprising insulating positively sloped ribs (7), in-between which a well (13) is formed. The upper electrode layer (2) has an extension over at least one positively sloped rib (7), and the well (13) is arranged on a first side (7), and a contact surface (4) is arranged on a second side (7″) of the positively sloped rib (7). The extension of the upper electrode layer (2) provides for at least part of said contact surface (4) being covered by said upper electrode layer (2). Thereby, the upper electrode layer (2) becomes accessible from below in the contact surface (4). The device (1) may be used for structured cathodes in active matrix displays, and/or for reducing the sheet resistance in transparent/semi-transparent cathodes.

The present invention relates to an electroluminescent device comprising a lower electrode layer, electrically accessible from below; an upper electrode layer, said lower electrode layer and said upper electrode layer being connectable to a driving circuit; one or more functional layers disposed between said lower and said upper electrode layer to form at least one electroluminescent area; and a relief pattern comprising at least two insulating positively sloped ribs, in-between which a well for said functional layers is formed. Said upper electrode layer has an extension over at least one positively sloped rib, and said well is arranged on a first side of said at least one positively sloped rib.

The invention also relates to the use of such a device, as well as to a method for the manufacture thereof An electroluminescent device is a device comprising electroluminescent material capable of emitting light when a current is passed through it, the current being supplied by means of electrodes.

A polymer-based light emitting diode (PLED) is a device in which an emissive polymer layer is sandwiched between a cathode and an anode on a substrate. An electrical voltage applied between the anode and the cathode will cause the polymer to emit light.

An organic light emitting diode (OLED) has a light-emitting layer which comprises a small molecule material sandwiched between the two electrodes.

Typically, in the present PLED/OLED technologies, the anode is ITO (indiumtinoxide). The best cathodes (electrons injectors) are usually metal with a low work function such as Ba, Ca, etc., covered by Al.

In PLEDs and OLEDs, the light-emitting layer is generally divided into individual electroluminescent elements, pixels, which can be switched between emitting and non-emitting states by altering the current flow through them.

Two alternative arrangements for controlling the pixels are generally used: passive matrix and active matrix.

Passive matrix displays consist of an array of pixels deposited on a patterned substrate in a matrix of rows and columns. Each pixel is a light emitting diode, formed at the intersection of each column and row line. In a passive matrix, a particular pixel is illuminated by applying electrical signals to the row line and column line (the intersection of which defines the pixel). An external controller circuit provides the necessary input power.

In an active matrix display, the array is still divided into a series of row and column lines, with each pixel formed at the intersection of a row and column line. However, each pixel now consists of an OLED in series with a thin film transistor (TFT). The TFT is a switch that can control the amount of current flowing through the OLED. In active matrix displays, typically the driving transistor (TFT) is connected on one terminal to a common power line and on the other to one of the two electrodes of the OLED. The data signal from the display controller regulates the gate voltage of the driving transistor via the column data line.

In the preferred Polymer OLED configuration the driving transistor is a PMOS (p-channel metal oxide semiconductor) transistor and it is connected to the anode of the PLED. The source (preferably a fixed voltage) is connected to the power line.

A capacitor with one terminal to the gate of the driving transistor, and the other terminal to a voltage line, maintains the voltage after the programming when the display controller goes to the following row selection line (addressing is typically one line at a time). The simplest pixel circuit is with 2TFT (one for the driving, the other for the selection).

Power, data lines, selection lines, selection switches, driving transistors, other transistors (there are different variants of pixel circuit) and the first OLED electrode are all integrated in the substrate. The OLED layers are deposited (evaporated, printed or spin-coated) on the first electrode. The last layer is the second electrode.

Typically, I=beta×(Vgs−Vt)ˆ2, where Vgs is the gate-to-source voltage and Vt the threshold voltage of the driving transistor. Beta is a constant that depends on the characteristics of the TFT. This current is delivered to the OLED that emits light (L˜I).

In the standard active matrix process described above, each OLED has one electrode that is controlled by a pixel element (the driving transistor). Typically, the second electrode of the polymer OLED (PLED) is common to all pixels. Indeed all the active area of the display is covered by metal layer(s) by means of deposition.

The common cathode solution is preferred for displays with bottom emission (emission is through the active substrate) since it is a relatively easy step not affecting much the process yield. Most of the driving methods are referring to a configuration with common cathode.

However, there are situations where structuring of the cathode is desirable, for example for large active matrix OLED displays realized with an amorphous silicon substrate. Improved amorphous silicon, with special driving methods for compensating the shift of the threshold voltage during operation, has been recognized as an option for large displays.

The electrodes, i.e. the cathodes as well as the anodes, may be transparent. By a transparent electrode is meant a very thin metal layer or a transparent conductor as ITO (sheet resistance is therefore higher) or a transparent conductive polymer (such as PEDOT (Poly(3,4-ethylenedioxythiophene) and PANI (polyaniline).

A transparent electrode may be common or structured, and may be used for both passive matrix and active matrix displays. It is very attractive for active matrix displays, since in bottom emission (emission from the PLED/OLED through the substrate) the pixel area can not be fully be used for the OLED since the pixel electronics is not transparent (a lot of metal).

In top emission the light goes through the second electrode that is deposited on the organic light emitting layer. Therefore this electrode has to be transparent.

However, the use of transparent/semi-transparent electrodes in normal processes, especially when it comes to active matrix displays with a common electrode, can be a problem due to the high sheet resistance.

In WO 02/089210, an electroluminescent device is disclosed, which has a patterned cathode layer. The pattern is formed by a relief pattern comprising overhanging sections and accompanying positively-sloped rib sections extending along and set up at distance of the overhanging sections. The object of WO 02/089210 is to provide a new, reliable, simpler and more economic manufacturing method for electroluminescent devices by the use of wet deposition methods.

The device in WO 02/089210 relates particularly to a matrix display of the passive type. There is no indication that the patterned cathode layer would be adapted for a matrix display of the active type. On the contrary, it is stated that active matrix displays generally comprise a single, common electrode. Further, the problem with sheet resistance in transparent electrodes is not dealt with.

Thus, there is a need for being able to use structured electrodes in active matrix displays as well as for improving the use of transparent electrodes.

An object of the present invention is to provide a new way of contacting an electrode of an electroluminescent device with a driving circuit, in order to overcome the drawbacks mentioned above.

This object is achieved by providing an electroluminescent device comprising a lower electrode layer, electrically accessible from below; an upper electrode layer, said lower electrode layer and said upper electrode layer being connectable to a driving circuit; one or more functional layers disposed between said lower and said upper electrode layer to form at least one electroluminescent area; and a relief pattern comprising at least two insulating positively sloped ribs, in-between which a well for said functional layers is formed. Said upper electrode layer has an extension over at least one positively sloped rib, and said well is arranged on a first side of said at least one positively sloped rib. A contact surface is arranged on a second side of said at least one positively sloped rib, wherein said extension provides for at least part of said contact surface being covered by said upper electrode layer, which upper electrode layer is thereby electrically accessible from below in said contact surface.

Thus, according to the invention, the electrical accessibility of electrodes are very much facilitated, which provides for the use of structured electrodes in active matrix displays, as well as for the improved use of transparent cathodes.

Since both electrodes are accessible to the driving circuit, much more freedom is given in the choice of the best driving circuit.

Said electroluminescent device is preferably arranged on a substrate. The use of a substrate facilitates the fabrication of the electroluminescent device.

According to one aspect of the present invention, said driving circuit is integrated in said substrate. E.g. in active matrix displays, the driving circuit, i.e. the pixel circuit, is integrated in the substrate. Since both of the two electrodes are accessible to the circuit, the configurations NMOS (n-channel metal-oxide semiconductor) driving transistor to cathode and PMOS (p-channel metal-oxide semiconductor) driving transistor to anode are possible. These configurations are preferred since the source of the driving transistor is attached to a fixed voltage line. In general, both electrodes can be controlled by pixel elements, for example 2 active elements—driving transistors—or one active element and one voltage level provided by a dedicated substrate line. This gives a lot of flexibility in the driving since the voltage of the cathode and of the anode of each (group of) OLED(s) can be settled separately within the frame time (pulsed voltage, negative and/or positive voltage).

It could be that the PMOS feeds the cathode of the OLED. In this case, since the source of the driving transistor is the cathode, the voltage at the source is not fixed. It can possibly also be the other way around, where for example it is a NMOS and it feeds the PLED from the cathode. Here, the source is connected to the power that has a fixed voltage. In an amorphous silicon substrate, NMOS is preferably fabricated. Therefore, the best solution is to drive the PLED from the cathode.

According to another aspect, said driving circuit is arranged outside said substrate. In this case, there are conduits from each electrode to the edge of said substrate. This is the case in passive matrix displays. There is a big advantage in being able to connect both electrodes to the driving circuit from underneath according to the invention, since then, the conducting properties of the electrodes are of less importance. Instead, any suitable good electrical conductor could be chosen.

In displays with a transparent cathode it is expected to realize better contacting for reducing the sheet resistance of the transparent/semi-transparent layer. Grating and metal shunting between pixels have been considered. In both cases the cathode contacts with the substrate are out of the active area of the display.

Preferably, said relief pattern further comprises at least one negatively sloped rib at a distance from said at least one positively sloped rib, which negatively sloped rib extends along said second side of said at least one positively sloped rib. The negatively sloped rib provides a convenient way of patterning the electrode.

According to one embodiment of the present invention, the electroluminescent device comprises at least two positively sloped ribs extending along a first and a second direction on said substrate. Preferably, said second direction is perpendicular to said first direction. Moreover, said negatively sloped rib may extend along one of, or both said first and said second direction on said substrate. Further, said contact surface may be arranged in both said first and said second direction. By these measures, desired variants of electroluminescent devices, adapted for different applications, may be formed.

According to a further aspect of the present invention, one of said functional layers comprises an electroluminescent polymer.

According to another aspect of the present invention, one of said functional layers comprises an electroluminescent small molecule material.

Preferably, said upper electrode layer is a cathode layer, and said lower electrode layer is an anode layer.,

The electroluminescent device according to the invention may be an active matrix display or a passive matrix display.

The present invention also relates to the use of an electroluminescent device as described above. Further it relates to a method for the manufacture thereof.

These and other aspects of the invention will be apparent from and elucidated with reference to the embodiments described hereinafter. The examples are intended to illustrate the invention and should in no way be considered to limit the scope of the invention.

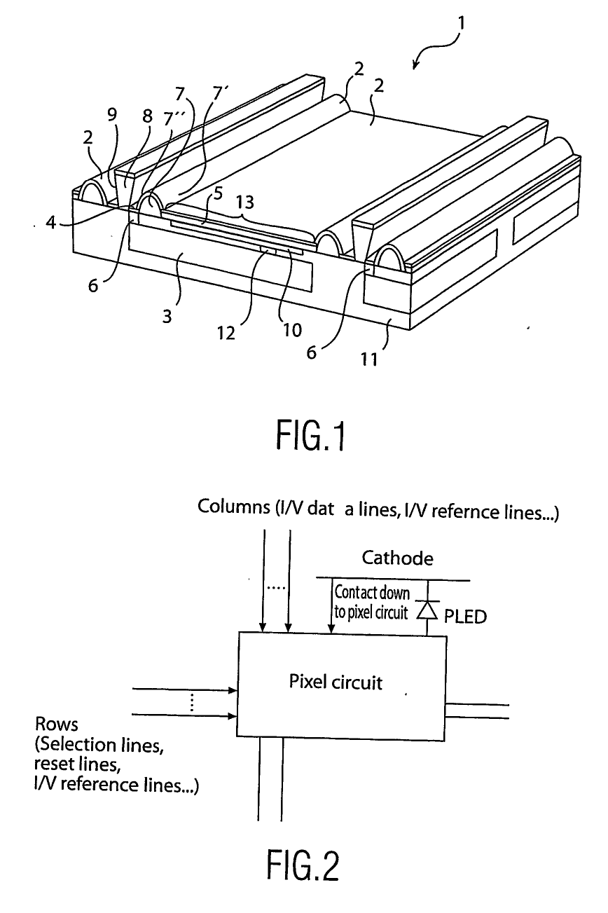

FIG. 1 shows a cross sectional view of a device according to the invention.

FIG. 2 shows an electrical description of a device according to the invention.

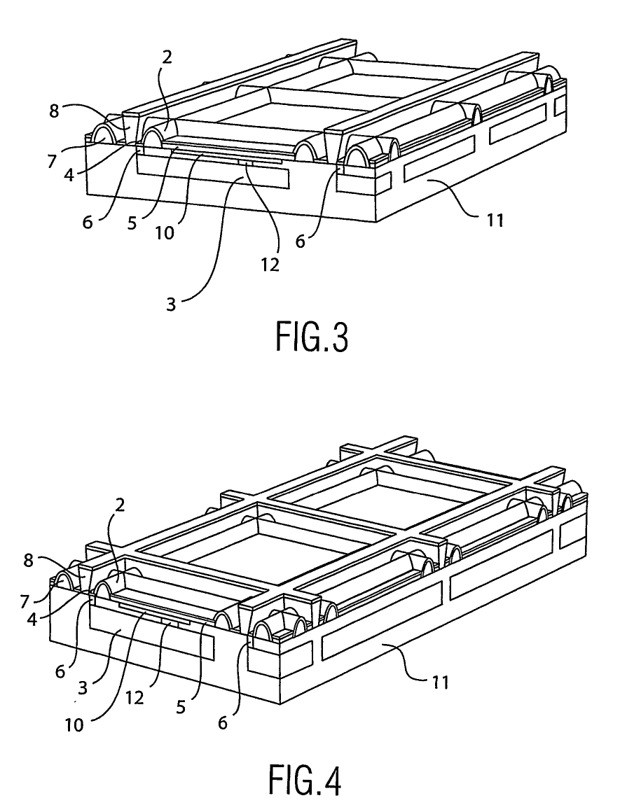

FIG. 3 is a cross sectional view of a device according to the invention, having cathode line structuring.

FIG. 4 is a cross sectional view of a device according to the invention, having a cathode pixel structuring (islands).

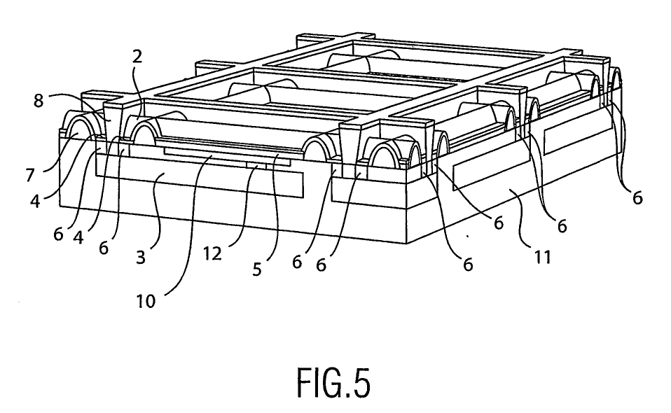

FIG. 5 is a cross sectional view of a device according to the invention, having an island structuring with openings on both four sides.

In the research work leading to the present invention, a new method for contacting an electrode in an electroluminescent device with a driving circuit, e.g. in a substrate, was found.

Embodiments of the invention will now be further described with reference to the accompanying figures.

In FIG. 1, an active matrix PLED is shown. The upper electrode layer (2) is the cathode layer, and the lower electrode layer (10) is the anode layer. The display is arranged on a substrate (11), and the driving circuit (3) is a pixel circuit integrated in the substrate (11). The anode (10) is in contact with the pixel circuit by a conductive line (12) in the substrate.

In order to be able to contact the structured cathode (2) of the PLED with the pixel circuit (3), there is an opening (4) on the external insulating functional layers (5) of the substrate (11). Thereby, a contact between the deposited structured cathode layer (2) and a metal line (6) in the substrate is allowed.

Two types of resists are deposited on the substrate:

The first define the regions where the functional polymer layer (5) is deposited by means of ink-jet printing. These resists are called positively sloped ribs (7), and they delimit an area called a well (13). The positively sloped ribs are also defined to exclude the openings (4) to be covered with polymers.

The second resist, the negatively sloped rib, (8) allows the structuring of the cathode. This type of rib is known since it is used for the line structuring of the cathode, which is a standard process used in passive matrix display. The slope (9) of the negatively sloped rib creates a shadow region, which discontinues the cathode metal surface. The negatively sloped rib (8) are placed between two positively sloped ribs (7) and doesn't cover the openings (4).

The opening (4), corresponding to the “contact surface”, is covered with the cathode metal and not with polymer. The openings (4) therefore become the contacts between the cathode (2) of the polymer OLED and a metal line (6) connected to the pixel circuit (3) as described in FIG. 2. An individual cathode element is thereby addressable via a contact between the cathode element and the pixel circuit.

The size of the contact surface (4) may vary, as long as it is sufficiently big to provide for a contact between the cathode and a metal line (6) connected to the pixel circuit (3). Further, not all of the contact surface (4) need to be covered with cathode metal. Suitably, however, the whole contact surface (4) is covered with cathode metal.

A larger contact surface (4) reduces the risk that polymers erroneously deposited in part of the contact surface (4) make the contact bad. The part covered with polymers doesn't give problems since it would correspond to a reverse biased diode (higher impedance) in parallel with the contact.

The expression “from below” defines a direction in an electroluminescent device. In an electroluminescent device having an upper and a lower electrode layer, the lower electrode layer is arranged below the upper electrode layer. If the device is built on a substrate, the substrate is arranged below the lower electrode. Thus, being electrically accessible from below means that an electrical connection can be established from the electrode to a circuit arranged immediately below the electrode.

Thus, electrical connections can be arranged from both of the electrode layers to a circuit arranged e.g. in the substrate below both electrodes. This is a big difference in relation to prior art, where only one of the electrodes may be contacted from below. The other one needs to be contacted from the side of the device.

By the expression “contact surface” is meant an area in which the upper electrode layer is accessible by the driving circuit. No functional layers are deposited in the contact surface.

The contact between the upper electrode layer and the driving circuit may be effected by a contact line in the substrate. The following materials may be used as a contact line according to the present invention: low resistive metal, such as Al, Cr, Mo, and combinations of these metals, or ITO. One examples include 80 nm Cr-500 nm Al-40 nm Cr.

A “driving circuit” according to the invention may be a pixel circuit, for example the basic pixel circuit described in U.S. Pat. No. 5,684,365, with a selection transistor enabling, by means of a row selection line, to write the voltage data signal from the column data voltage on the gate of the driving transistor, or the pixel circuits described in U.S. Pat. No. 6,229,506 B1.

In case of a passive matrix display, the “driving circuit” consists of two or more conductive lines from the edge of the display to the pixel.

By the expression “negatively sloped rib” is meant a section, the slope of which creates a shadow region. The negatively sloped rib may under some circumstances include a section having perpendicular side walls. The negatively sloped rib has a function of patterning the upper electrode layer, by providing a shadow region in which electrode material is not deposited when depositing the upper electrode layer. The negatively sloped ribs are preferably made of an insulating material, and suitable materials include polymer-based photoresists, SiO₂, Si₃N₄ Al₂O₃. The breadth of the negatively sloped ribs are preferably in the range of 1 to 50 μm and the height of the negatively sloped ribs are preferably in the range of 0.3 to 10 μm.

By the expression “a positively sloped rib” is meant a section which does not have a shadow region and may include a section having perpendicular side walls. The positively sloped ribs need to allow the formation of an electrode layer having an extension over the entire surface of the rib. The positively sloped ribs serve to define a well, in which the functional layers is to be deposited. The positively sloped ribs are also defined to exclude the openings to be covered with polymers. The positively sloped ribs are made of an insulating material, and suitable materials include photoresists, such as novolak resins like HPR504, but also Acrylic and Poly-Imide based resins. The breadth of the positively sloped ribs are preferably in the range of 1-50 μm and the height is preferably in the range of 0.2-10 ρm. See further WO 02/089210.

Suitably, the negatively sloped ribs are arranged at a distance from the positively sloped ribs.

The positively and negatively sloped ribs are suitably made of an insulating material. The negatively sloped ribs may be formed of negative photoresists. The negatively sloped ribs are the connection to the next pixels. If they are electrical conducting they will short the pixels.

The positively sloped rib in the example above has a direct contact with the anode and the cathode. If it would be electrically conducting it would short the pixels. However, it can be made of conducting material if a contact with the anode is avoided.

By the expression “well” is meant an area delimited by positively sloped ribs. Depending on the type of electroluminescent device and method of deposition, the ribs may form a closed well or a well open ended in one or more sides to form a channel. Preferably, the positively sloped ribs delimit quadrilateral areas.

The cathode is suitably applied by PVD (Physical Vapour deposition). For example, the following materials may be used as a cathode according to the present invention: Ba, Ca, LiF, Mg, Al, or Ag. Examples of materials used in transparent/semitransparent cathodes are: thin layers of Ba, Ca, LiF, Mg, Al, Ag Mg and relatively thick layers of ITO. The thickness of the cathode layer is preferably in the range of 5 to 70 nm for the metals and up to 200 nm for the ITO.

The anode is suitably applied with a sputter deposition. For example, the following materials may be used as an anode according to the present invention: ITO or other transparent anode materials e.g. fluoridated ITO. Examples of materials used in transparent/semitransparent anodes are: different kind of metals, sometimes topped with ITO. The metals can be e.g. Al, Mo, Cr, Ag etc. Also just ITO is possible for a fully transparent device. The thickness of the anode layer is preferably in the range of 10-10,000 nm.

Methods for anode and cathode formation is conventional and well-known to those skilled in the art.

The electroluminescent device comprises one or more functional layers. Examples of such functional layers are electroluminescent, charge transport and charge injecting layers.

At least one of the functional layers is an electroluminescent layer which are made of an electroluminescent material. The type of electroluminescent material used is not critical and any electroluminescent material known in the art can be used. The thickness of the electroluminescent layer is preferably in the range of 10 to 250 nm, wherein a usual thickness is 70 nm.

One example of an electroluminescent polymer for use in the present invention is poly(p-Phenylene vinylene) (PPV).

One example of an electroluminescent small molecule material for use in the present invention is 8-hydroxy-quinolin-aluminum.

The electroluminescent polymeric material may be deposited by means of ink-jet printing with an ink-jet printer.

The small molecule electroluminescent material may be deposited with an evaporation process, using PVD (Physical Vapour Deposition).

Optionally, the electroluminescent device comprises further, preferably organic, functional layers disposed between the electrodes. Such further layers may be hole-injecting and/or transport (HTL) layers and electron-injecting and/or transport (ETL) layers. One example of such a layer is PEDOT.

Generally, the electroluminescent device comprises a substrate. Preferably, the substrate is transparent with respect to the light to be emitted. Suitable substrate materials include glass, plastics and metals. The substrate provides the supporting surface for the relief pattern.

Although in its broadest sense, the invention is applicable to electroluminescent devices having a single electroluminescent area, the invention is particularly beneficial for an electroluminescent device comprising a plurality of light emitting areas.

### EXAMPLE 1

### Line Structuring of the Cathode

If the negatively sloped ribs are deposited only along one direction, like in passive matrix, see FIG. 3, and a metal line run underneath the openings, the cathode is line-structured.

This is a suitable configuration for amorphous silicon where pulsing of the cathode one line at a time is desirable.

### EXAMPLE 2

### Pixel Structuring of the Cathode (Islands)

If the negatively sloped ribs are also deposited along the perpendicular direction, it is possible to define cathode islands corresponding to each pixel completely isolated from each other, see FIG. 4.

This is an optimal configuration for in-pixel cathode driving.

### EXAMPLE 3

### Islands with Contacts on the Four Sides

Use of a transparent/semi-transparent cathode in a normal process can be a problem due to the high sheet resistance. Shorting the cathode with metal lines running on the substrate prevents the problem. Both the configurations previously described can be used.

Openings could be defined on the four sides of the pixel for reducing the resistance of the cathode even more. In this case the printing must be carefully performed on the PLED area only, see FIG. 5. The metal can also be partly below the negatively sloped rib to further reduce the resistance.

### EXAMPLE 4

### Manufacturing Method

In the following, a method for manufacturing a device according to the invention is described.

First, the active matrix processing is made, ending with an anode (ITO). Then, positively sloped ribs are deposited on the substrate, whereby a well is formed. The ribs allow making an opening through the isolation (oxide, nitride) to ITO. Thus, an opening, a contact surface, to the underlying metal can be made.

The next step is to make the build-in shadow mask. In a preferred process, a negative photoresist is used. This resist is exposed so that it forms a negative shape. Then, with an inkjet printer, the PEDOT and one or more color PPV are printed on the ITO areas. The well structure prevents overflow. Therefore the contact surfaces are not covered with polymers. After the printing the cathode is deposited. The contact surface allows the cathode to get into contact with the underlying metal. Due to the negative shape of the negatively sloped rib the cathode is structured.

Thus, the present invention may be used for structured cathodes in active matrix displays, and/or for reducing the sheet resistance in transparent/semi-transparent cathodes.

1. An electroluminescent device (1) comprising:
a lower electrode layer (10), electrically accessible from below,
an upper electrode layer (2), said lower electrode layer (10) and said upper electrode layer (2) being connectable to a driving circuit (3),
one or more functional layers (5) disposed between said lower (10) and said upper (2) electrode layer to form at least one electroluminescent area, and
a relief pattern comprising at least two insulating positively sloped ribs (7), in-between which a well (13) for said functional layers (5) is formed, wherein
said upper electrode layer (2) has an extension over at least one positively sloped rib (7), and said well (13) is arranged on a first side (7′) of said at least one positively sloped rib (7), characterized in that a contact surface (4) is arranged on a second side (7″) of said at least one positively sloped rib (7), wherein said extension provides for at least part of said contact surface (4) being covered by said upper electrode layer (2), which upper electrode layer (2) is thereby electrically accessible from below in said contact surface (4).

2. An electroluminescent device (1) according to claim 1, wherein said device (1) is arranged on a substrate (11).

3. An electroluminescent device (1) according to claim 1, wherein said driving circuit (3) is integrated in said substrate (11).

4. An electroluminescent device (1) according to claim 1, wherein said driving circuit (3) is arranged outside said substrate (11).

5. An electroluminescent device (1) according to claim 1, wherein said relief pattern further comprises at least one negatively sloped rib (8) at a distance from said at least one positively sloped rib (7), which negatively sloped rib extends along said second side (7″) of said at least one positively sloped rib (7).

6. An electroluminescent device (1) according to claim 1, comprising at least two positively sloped ribs (7) extending along a first and a second direction on said substrate (11).

7. An electroluminescent device (1) according to claim 6, wherein said second direction is perpendicular to said first direction.

8. An electroluminescent device (1) according to claim 6, wherein said negatively sloped rib (8) extends along one of said first and said second directions on said substrate (11).

9. An electroluminescent device (1) according to claim 6, wherein said negatively sloped rib (8) extends along both said first and said second direction on said substrate (11).

10. An electroluminescent device (1) according to claim 1, wherein said contact surface (4) is arranged in both said first and said second direction.

11. An electroluminescent device (1) according to claim 1, wherein one of said functional layers (5) comprises an electroluminescent polymer.

12. An electroluminescent device (1) according to claim 1, wherein one of said functional layers (5) comprises an electroluminescent small molecule material.

13. An electroluminescent device (1) according to claim 1, wherein said upper electrode layer (2) is a cathode layer.

14. An electroluminescent device (1) according to claim 1, wherein said lower electrode layer (10) is a cathode layer.

15. An electroluminescent device (1) according to claim 1, wherein said electroluminescent device (1) is an active matrix display.

16. An electroluminescent device (1) according to claim 1, wherein said electroluminescent device (1) is a passive matrix display.

17. Use of an electroluminescent device (1) according to claim 1.

18. A method for the manufacture of an electroluminescent device (1) comprising:
providing a lower electrode layer (10), electrically accessible from below,
providing a relief pattern comprising at least two insulating positively sloped ribs (7) in-between which a well (13) is formed,
providing one or more functional layers (5) in said well on a first side (7′) of at least one positively sloped rib (7), to form at least one electroluminescent area,
providing a contact surface (4) on a second side (7″) of said at least one positively sloped rib (7), and
providing an upper electrode layer (2) having an extension over said at least one positively sloped rib (7), wherein said extension provides for at least part of said contact surface (4) being covered by said upper electrode layer (2), which upper electrode layer (2) is thereby electrically accessible from below in said contact surface (4).
